(19) United States
(12) Patent Application Publication
(10) Pub. No.: US 2005/0282580 A1
(43) Pub. Date: Dec. 22, 2005

(54) Video and audio synchronization

(75) Inventors: Miikka Tuori, Tampere (FI); Jussi Kujanpää, (US); Seppo Ingalsuo, Tampere (FI); Markku Vorne, Espoo (FI)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(73) Assignee: Nokia Corporation

(21) Appl. No.: 11/145,544

(22) Filed: Jun. 3, 2005

(30) Foreign Application Priority Data
Jun. 4, 2004 (FI) 20045211

(51) Int. Cl. H04Q 7/20; H04M 1/00

(52) U.S. Cl. 455/556.1; 455/454

(57) ABSTRACT

A device (1) (and corresponding system, method and computer program product) comprises at least a first control block (2), a second control block (3), a bus (9) between the first control block (2) and the second control block (3) for transmitting information between the first control block (2) and the second control block (3), an electro-acoustic converter (5) adapted to the first control block (2) for generating an audible signal on the basis of an audio frame, video presentation means (3.8, 4) for presenting video information on the basis of video frames, and a synchronizing parameter (3.12) for synchronizing the presentation of video information to the presentation of audio information. The first control block (2) is adapted to transmit a request message to the second control block (3) for requesting an audio frame to be transmitted from the second control block (3) to the first control block (2).

### CROSS-REFERENCE TO RELATED APPLICATIONS

This application claims priority under 35 USC §119 to Finnish Patent Application No. 20045211 filed on Jun. 4, 2004.

### FIELD OF THE INVENTION

The present invention relates to a device comprising at least a first control block running a first operating system, a second control block running a second operating system, a bus between said first control block and said second control block for transmitting information between said first control block and said second control block, electro-acoustic converter controlled by said first control block for generating audible signal on the basis of an audio frame, and video presentation means controlled by said second control block for presenting video information on the basis of video frames. The invention also relates to a system comprising at least a first control block running a first operating system, a second control block running a second operating system, a bus between said first control block and said second control block for transmitting information between said first control block and said second control block, electro-acoustic converter controlled by said first control block for generating audible signal on the basis of an audio frame, and video presentation means controlled by said second control block for presenting video information on the basis of video frames. The invention relates to a method for presenting audio and video information in a device, which comprises at least: a first control block running a first operating system, a second control block running a second operating system, a bus between said first control block and said second control block for transmitting information between said first control block and said second control block, electro-acoustic converter controlled by said first control block for generating audible signal on the basis of an audio frame, and video presentation means controlled by said second control block for presenting video information on the basis of video frames. The invention further relates to a computer program product comprising machine executable steps for presenting audio and video information in a device, which comprises at least: a first control block running a first operating system, a second control block running a second operating system, a bus between said first control block and said second control block for transmitting information between said first control block and said second control block, electro-acoustic converter controlled by said first control block for generating audible signal on the basis of an audio frame, and video presentation means controlled by said second control block for presenting video information on the basis of video frames.

### BACKGROUND ART

There are devices in which multimedia information can be presented. Multimedia information often comprises audio and video components (tracks) which may have been encoded and/or compressed before they are delivered to the device. When playing back a multimedia presentation which is composed of a video track and an associated audio track, the two media tracks should be synchronized to achieve a pleasant user experience. This audio/video synchronization is also known as “lip sync”.

Missing synchronization can be easily perceived when the lips of a speaker are not moving in sync with the heard speech. There exists studies on the effect of the AN-sync accuracy to the subjective quality of the multimedia presentation. For instance, Ralf Steinmetz: Human Perception of Jitter and Media Synchronization (Human perception of jitter and media synchronization; Steinmetz, R.; Selected Areas in Communications, IEEE Journal on, Volume: 14, Issue: 1, January 1996 Pages: 61-72) concludes that the audio and video tracks are perceived to be in-sync when the skew between the two media is between −80 ms and +80 ms (+meaning audio ahead of video).

In general, the principal method of adjusting the AV-sync is to let audio “run free” and adjust the rendering time instant of each video frame accordingly. I.e., the industry standard approach is to synchronize the video to audio. This approach originates from the perceptual psychology: humans perceive jitter in the timing of video frames less disturbing than gaps in the stream of audio samples.

To offer customers the highest application performance, some wireless communication devices have a discrete cellular modem ASIC, separated from an application engine ASIC. Both cellular modem ASIC and application engine ASIC contain processor cores in which they run their independent operating system environments. In these kind of devices the audio hardware (i.e., the A/D and D/A converters, power amplifiers, and galvanic audio routing control) is connected to the cellular modem ASIC for optimised telephony, system modularity and power management reasons. The operating system on the application engine ASIC is running the user interface software of the device, and therefore the display driver software is running on the application engine ASIC. Moreover, the audio and video codecs (such as AMR-NB or H.263 decoders, respectively) used by the applications are executed on the application engine ASIC.

This setup means that there needs to be an inter-ASIC bus between the cellular modem ASIC and the application engine ASIC, to enable the audio data transfer from the audio codec to the audio hardware. The dual-ASIC system is illustrated (on a high-level) in FIG. 1. It shows the data paths that are used for the playback of audio. It should be noted that FIG. 1 does not show all the buses, peripherals, or software modules associated with these ASICs.

A common method for inter-ASIC audio data transfer is to use a serial bus as the physical layer. For example, the I²S bus is widely used. On top of the physical layer, it is common to utilize a link layer protocol (level 2 in the OSI model) for transferring the audio data in fixed-length frames. Typical frame lengths range from few milliseconds to some hundreds of milliseconds.

In addition to the above described “audio-only” use case, the baseband engine must be capable of rendering a multimedia presentation which consists of a video track and a synchronized audio track. In this audio and video use case, the display is used for the video track rendering. A software module called AV-sync Module controls the rendering time instant of each video frame. Therefore, the video frames flow through the AV-sync Module. The audio and video data paths are visualized in FIG. 1.

In the dual-ASIC system, the above mentioned approach in which video is synchronized to audio means that the application engine ASIC needs to have a synchronizing parameter which can be implemented, for example, as a register or a memory slot, from which the AV-sync Module can read the value of how many audio samples have been played out from the loudspeaker. The AV-sync Module will then adjust the presentation time of the video frames accordingly.

There are some problems with the above described approach. It is not easy to arrange the synchronization between the two ASICs so that the rendering time instant of each video frame is determined by the AV-sync Module on the APE (Application Engine ASIC), and the rendering time instant of each audio sample is determined by the audio driver on the CMT (Cellular Modem ASIC).

In other words, one problem is how to convey the D/A converter clocking information from the cellular modem ASIC to the APE for the updating of the Sync Clock.

A known method for enabling the inter-ASIC audio/video synchronization is to use a common clock signal for both ASICs. This kind of arrangement is disclosed in the U.S. patent application US 2003/0094983 A1 Method and device for synchronising integrated circuits (Nokia Corporation; inventors: Takala, Janne and Mäkelä, Sami). In this method, both ASICs maintain their own hardware clock registers which count the number of pulses in the common clock signal. When necessary, the clock registers are cleared using a common reset signal. In an implementation based on this solution, the D/A converter would get its clock signal from a source which is common with the application engine ASIC. The Sync Clock on the application engine ASIC would be updated based on this common clock signal. The drawback in this method lies in the fact that in a cellular speech call use case the common clock must be synchronized with the cellular network (e.g. GSM or WCDMA network). This means added complexity in the actual hardware implementation, since the common clock must be synchronized with the RF parts of the device.

Another known method is to use the I²S bus as the inter-ASIC audio bus, and configure the cellular modem ASIC as a master and the application engine ASIC as a slave. Physically, I²S is a three-line serial bus, consisting of a line for two time-multiplexed data channels (i.e., the left and right audio channels), a word select line and a clock line. In audio playback, the master provides the slave with the clock signal (derived from the D/A converter clock) and with the word select information. The slave responds by transmitting the interleaved (left-right-left-right- . . . ) audio samples. One drawback of this method is the need for a separate word select line, which increases the pin count of both ASICs and the amount of wiring on the circuit board.

### SUMMARY OF THE INVENTION

In the present invention there is provided a device, a system, a method and a computer program product for video and audio synchronization. The device according to the present invention is primarily characterised in that said first control block is adapted to transmit a request message to said second control block for requesting an audio frame to be transmitted from said second control block to said first control block, and that said first control block is adapted to play out said audio frame via the electro-acoustic converter within a specified time after said request.

The system according to the present invention is primarily characterised in that said first control block is adapted to transmit a request message to said second control block for requesting an audio frame to be transmitted from said second control block to said first control block, and that said first control block is adapted to play out said audio frame via the electro-acoustic converter within a specified time after said request.

The method according to the present invention is primarily characterised in that the method comprises:
transmitting a request message from said first control block to said second control block for requesting an audio frame to be transmitted from said second control block to said first control block, and
playing out said audio frame via the electro-acoustic converter within a specified time after said request under the control of said first control block.

The computer program product according to the present invention is primarily characterised in that the computer program product further comprises machine executable steps for:
transmitting a request message from said first control block to said second control block for requesting an audio frame to be transmitted from said second control block to said first control block, and
playing out said audio frame via the electro-acoustic converter within a specified time after said request under the control of said first control block.

The present invention uses timing information of audio frame transfers to enable synchronization between audio and video. This means that no additional hardware is needed. Moreover, no additional signalling or messages are needed in the audio protocol; the solution relies on the same audio protocol which is used in the audio-only use case.

The invention enables the audio/video synchronization without any additional hardware described in the prior art solutions. There is no need for a common clock signal, common reset signal, word select line, or hardware clock registers on both ASICs. This means that the silicon area and the pin count on both cellular modem ASIC and application engine ASIC and the amount of wiring on the circuit board can all be reduced. Instead, the solution is based on the software implementation of the audio protocol.

Moreover, the audio protocol sequence can be exactly the same regardless of whether it is used in an audio-only use case or in an audio+video use case. Thus, there is no additional signalling or protocol overhead incurred from the enabling of the AV-sync in the system.

Furthermore, the audio protocol can be implemented in software on top of any high-speed serial bus. If the bus has a high enough bandwidth, the audio transmissions can actually be time-multiplexed with other data transmissions needed between the ASICs. This reduces the overall pin count even more, since there is no need for separate “audio” and “other data” buses.

A high-speed bus (e.g. several tens of megabits per second) will also provide a lower audio signal latency than e.g. the I²S bus.

Due to the software implementation, the audio protocol is also easily configurable for different platforms and needs.

All the listed advantages reduce the power consumption of the mobile device. This is also very important property of the invention especially when implemented in portable devices.

The invention can also be implemented in devices in which digital signal processor and a controller are integrated on the same chip.

### DESCRIPTION OF THE DRAWINGS

In the following the invention will be described in more detail with reference to the appended drawings, in which

FIG. 1 depicts a device according to an example embodiment of the present invention,

FIG. 2 shows as a high level view the data paths that are used for the playback of audio and video in a device according to an example embodiment of the present invention,

FIG. 3 depicts an example of an audio playback protocol as a signalling diagram,

FIG. 4 depicts a device according to another example embodiment of the present invention, and

FIG. 5 depicts as a flow diagram an example of the synchronization control according to the present invention.

### DETAILED DESCRIPTION OF THE INVENTION

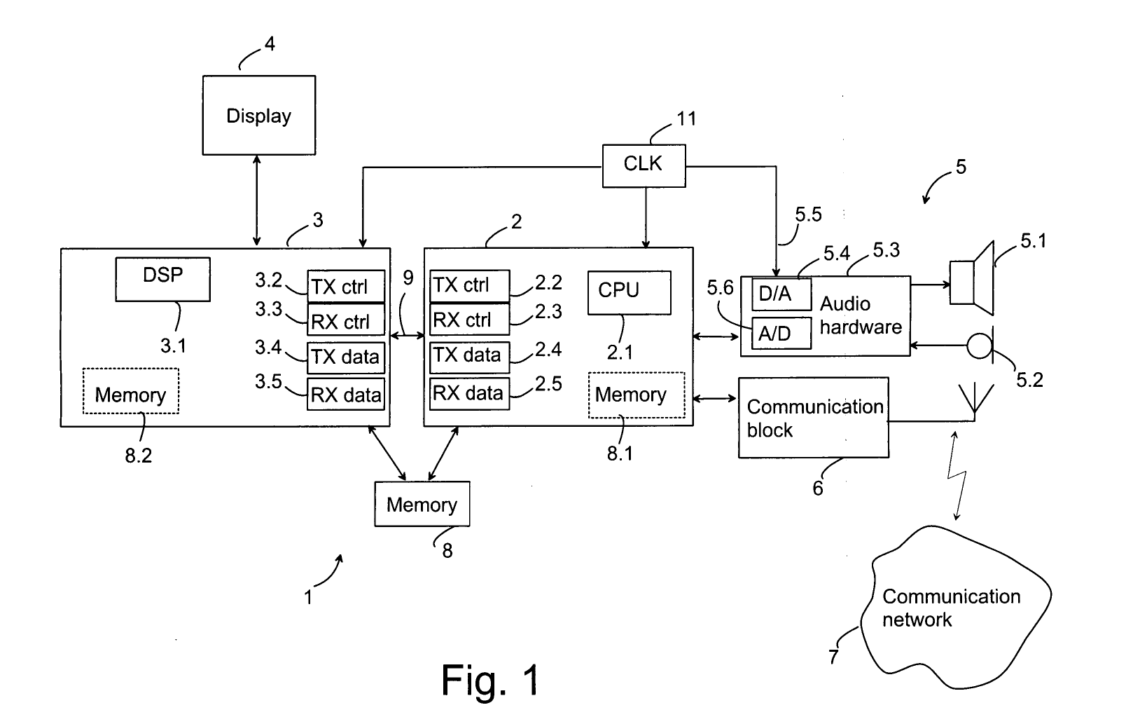

In the following a device 1 depicted in FIG. 1 will be used as an example embodiment of the present invention. The device 1 can be any device in which multimedia presentations can be presented and audio and video tracks of a multimedia presentation are at least partly processed by separate processors. As non-limiting examples of such devices are wireless communication devices, DVD players, video play back devices, laptop PCs, etc.

The device 1 in FIG. 1 comprises a first control block 2 and a second control block 3. The first control block 2 comprises a first controller 2.1, e.g. The second control block 3 comprises a second controller 3.1. The controllers 2.1, 3.1 can be e.g. a CPU, a MCU, a digital signal processor DSP, etc. The control blocks 2, 3 can be implemented in a same integrated circuit (IC) or in separate integrated circuits. The integrated circuits can be ASICs or some other kind of integrated circuits in which controllers or other elements utilising software (program code, machine executable steps for doing something) can be implemented. The first control block 2 is adapted to be used inter alia as a cellular modem, a baseband engine and as a controller of the device. The second control block 3 is adapted to be used inter alia as an application engine.

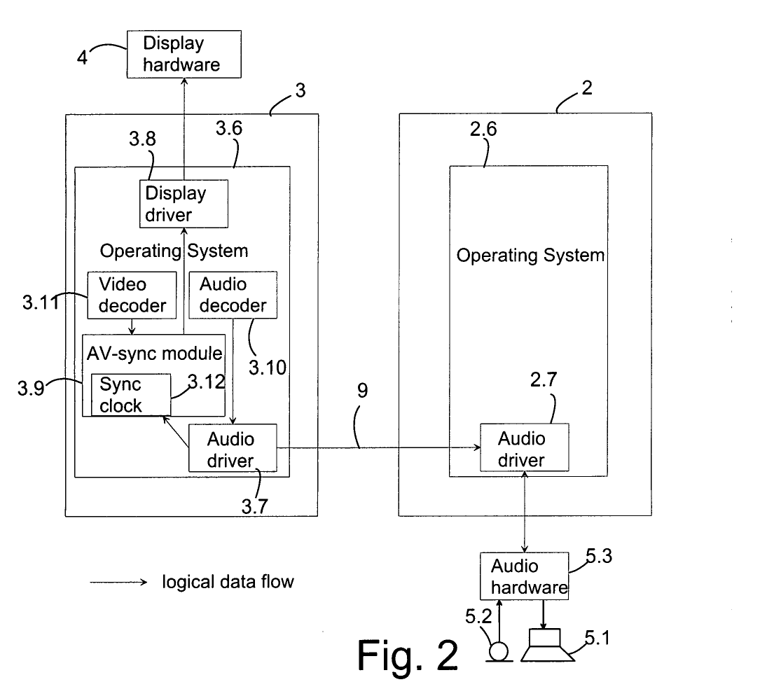

The operation of the first control block 2 is controlled by a first operating system 2.6 (FIG. 2). Respectively, the operation of the second control block 3 is controlled by a second operating system 3.6. The first 2.6 and the second operating system 3.6 are implemented as a program code executed by the first controller 2.1 or the second controller 3.1, respectively. The first operating system 2.6 controls inter alia the operation of a first audio driver 2.7 of the first control block 2 when necessary. In the second control block 3 there is a second audio driver 3.7 which is controlled by the second operating system 3.6. In addition to that, the second control block 3 also comprises a display driver 3.8, a synchronization module 3.9, audio decoder 3.10 and a video decoder 3.11.

The first operating system 2.6 and the second operating system can be similar operating systems, for example Symbian™ operating systems, or they can be different operating systems.

In this example embodiment of the present invention in FIG. 2 there is a bus 9 between the first control block 2 and the second control block 3 for exchange of information and control. The bus can be a serial bus or a parallel bus. To transfer commands between the first 2 and the second control block 3 a first control transmission channel 2.2, a first control receiving channel 2.3, a first data transmission channel 2.4 and a first data receiving channel 2.5 are formed in the first control block 2. Respectively, a second control transmission channel 3.2, a second control receiving channel 3.3, a second data transmission channel 3.4 and a second data receiving channel 3.5 are formed in the second control block 3. The channels are logical channels and they can be implemented in many different ways in practical applications. For example, the control channels 2.2, 2.3, 3.2, 3.3 may use the same line (not shown) of the bus 9 or all of the control channels 2.2, 2.3, 3.2, 3.3 may use a separate line of the bus 9. The same applies to the data channels 2.4, 2.5, 3.4, 3.5. The bus may be full duplex, so there are separate channels for receive and transmit directions, or the bus may have a separate line for both directions. It is also possible that the channels 2.2, 2.3, 2.4, 2.5, 3.2, 3.3, 3.4, 3.5 utilise some of the existing line(s) of the bus. Hence, there is no need to have any additional lines to implement the invention thus further simplifying the circuitry needed.

As shown in FIG. 1 the device 1 also comprises a display 4 and audio means 5, such as a loudspeaker 5.1 (an electro-acoustic converter), a microphone 5.2 (an acoustic-electric converter) and other audio hardware 5.3, for example amplifiers. There is also a communication block 6 in the device of FIG. 1 for communication between the device and a communication network 7. The communication block 6 may comprise e.g. a transmitter/receiver for communicating with a cellular network. The device 1 further comprises a memory 8 for storing information, programs etc. The memory 8 may be common to both control blocks 2, 3 and/or the memory 8 may be divided into separate memory areas or memory circuits 8.1, 8.2 for the first control block 2 and the second control block 3.

In a device of FIG. 1 the multimedia presentations can be stored to the memory 8 wherein the multimedia presentations can be retrieved from the memory 8 during playback. It may also be possible to download multimedia presentations from the network 7 to be stored to the memory 8 and/or for playback. In the following description of an example method of the present invention it is assumed that the multimedia presentation is stored in encoded form into the memory 8 from where the multimedia presentation is retrieved for playback.

In FIG. 2 also the audio and video data paths that are used in audio and video playback are shown as a high level view. The arrows indicate the data paths.

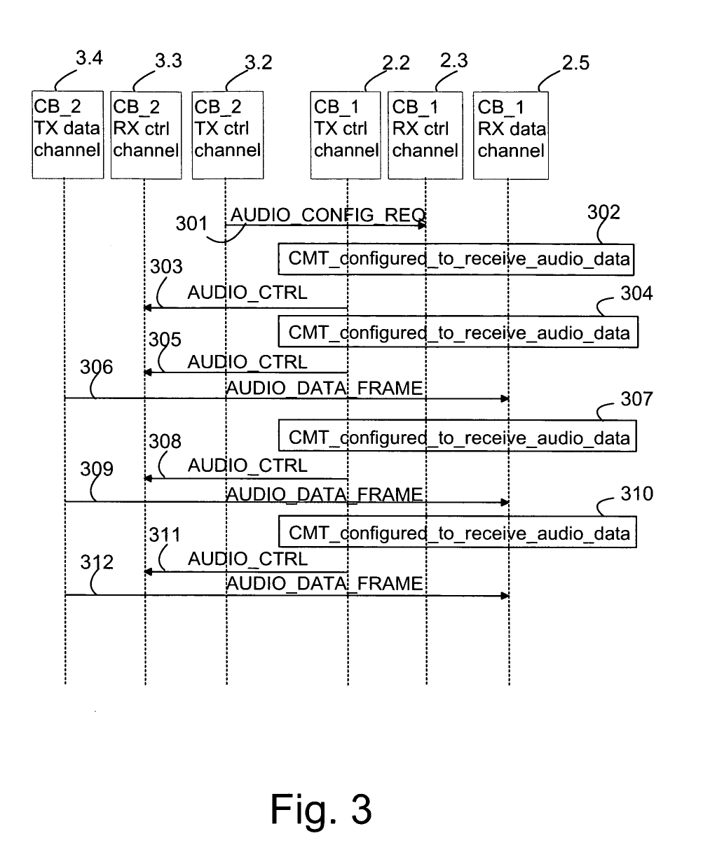

In FIG. 3 an example of an audio playback protocol is depicted as a signalling diagram. When the playback of a multimedia presentation including audio and video tracks is started the second control block 3 (CB_2) forms an audio configuration request message. The audio configuration request message contains the necessary initialisation information for the first audio driver 2.7 of the first control block 2. The second control transmission channel 3.2 transmits the audio configuration request message to the first control block 2 (arrow 301 in FIG. 3). The first control receiving channel 2.3 receives the message. The first controller 2.1 examines the message and determines that the first control block 2 (CB_1) needs to be configured to receive data from the data transmission channel 3.4 of the second control block 3 (block 302 in FIG. 3). When the configuration is performed the first audio driver 2.7 is initialised. The first audio driver 2.7 sets one or more return values indicative of whether the initialization was successful or not.

When the configuration is performed the first controller 2.1 forms a configuration reply message. The configuration reply message is included with the return values from the first audio driver 2.7 of the first control block 2. The configuration reply message is transmitted 303 by the first control transmission channel 2.2 to the second control block 3. The second control receiving channel 3.3 receives the message and the second controller 3.1 of the second control block 3 examines the message to determine whether the initialisation has been successful. If the first audio driver 2.7 is properly configured for receiving audio information, the first controller 2.1 configures 304 the first data receiving channel 2.5 to receive audio data and the first audio driver 2.7 starts to generate periodic audio control request messages (305, 308, 311 in FIG. 3).

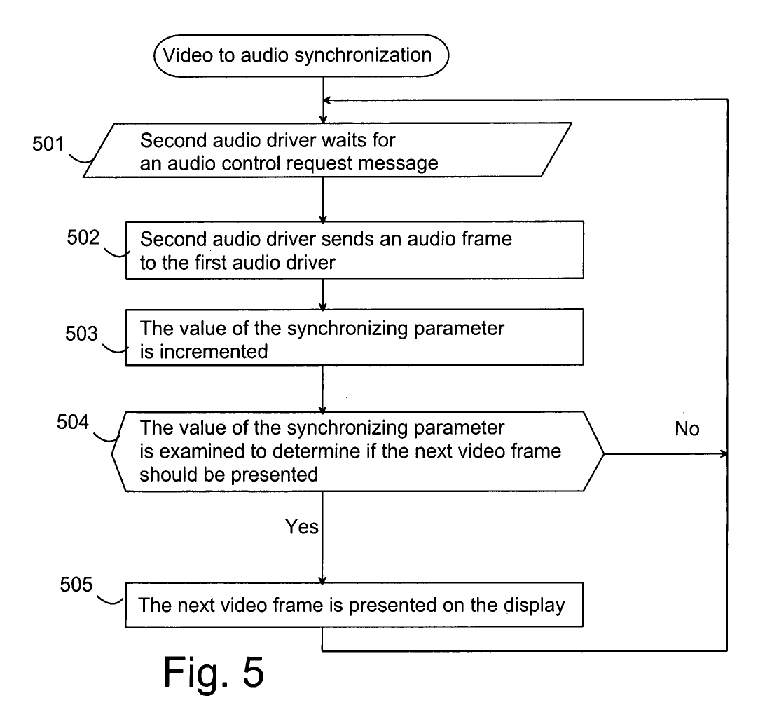

At a proper moment the first audio driver 2.7 (FIG. 2) sends the audio control request message via the first control transmission channel 3.2 (FIG. 3). The audio control request message is received by the second control receiving channel 3.5 (FIG. 1) and examined by the second audio driver 3.7 (FIG. 2). When the second audio driver 3.7 determines (block 501 in FIG. 5) that an audio frame i.e. a frame including decoded information of the audio track should be transmitted 502 to the first control block 2, The audio frames are transmitted from the second control block 3 by the second data transmission channel 9 (FIG. 2) and received in the first control block 2 by the first data receiving channel 2.7 (arrows 306, 309, 312 in FIG. 3). After each audio frame the first controller 2.1 configures 304, 307, 310 the first data receiving channel 2.5 to receive a new audio data frame.

The timing of the transmission of the audio control request messages is based on the timing of the D/A converter 5.4 (FIG. 1). The timing is based on the D/A converter clock signal 5.5 which can be generated, for example, by the clock generator 11 (FIG. 1). When the first audio driver 2.7 has received a new audio frame the first audio driver 2.7 uses the information included in the audio frame to provide digital values representing the audio signal to the D/A converter 5.4 which performs digital to analog conversion on the basis of the provided values. The analog signal can then be converted to acoustical signal by e.g. the loudspeaker 5.1. When audio information included in one audio frame is converted to acoustical signal the next frame should be transmitted to the first audio driver 2.7 for processing. The transmission of the next audio frame can be synchronized, so that the possible delays in transmission, processing and conversion of the audio frame into acoustical signal (group delay) can be taken into consideration and the audio frame is ready for conversion in the first audio driver 2.7 at a proper moment. Hence, the transmission sequence of the audio control request messages has substantially constant duration and is substantially the same as the length of the audio frame.

The A/D converter 5.6 depicted in FIG. 1 converts analog signals of the microphone 5.2 into digital form, which is known as such.

The second audio driver 3.7 can request decoded audio information from the audio decoder 3.10 when necessary. Then the audio decoder 3.10 may retrieve encoded audio information from the memory 8 when necessary.

The second audio driver 3.7 increments 503 (FIG. 5) the value of a synchronizing parameter 3.12 (such as a sync clock) according to the frame length after each audio control request message. The synchronizing parameter 3.12 indicates, for example, how many audio samples have been decoded and output. This synchronizing parameter 3.12 can be used in the timing of the presentation of the video track in the following way, for example.

The synchronization module 3.9 determines 504 the proper timing of the video frames by e.g. calculating how many audio samples or audio frames are presented for each video frame. For example, if the length of the audio frames is 10 ms and the video rendering rate is 25 frames/s, one video frame will be presented after every 4th audio frame. It should be noted here that one video frame may consist of two half frames (interleaved video) wherein the presentation rate of the half frames is twice the full frames. In the example above this means that one half frame should be presented after every other audio frame. However, the invention is not limited to the above mentioned frame lengths and rendering rates.

The synchronization module 3.9 detects the increment of the synchronizing parameter 3.12 and if the new value of the synchronizing parameter 3.12 indicates that the time to render 505 one video frame has arrived the synchronization module 3.9 retrieves next video frame of the video track and sends it to the display driver 3.8. The video frames may have been previously decoded by the video decoder 3.11 or the synchronization module 3.9 instructs the video decoder 3.11 to decode the next video frame when it is determined that the next video frame should be presented on a display 4.

By the method described above the proper synchronization of video to audio can be achieved without any need for additional wiring or transmission of timing information.

In the following, some guidelines for implementing the present invention are formulated. First, from the second control block 3 (application engine) point of view, each audio frame transfer should be started based on a request signal from the first control block 2. The first control block 2 generates the request signal based on the D/A converter clock signal 5.5. In other words, the first control block 2 should ask for a new frame of data just at the precise moment when there is a need for it. The request signal should be generated periodically (the period should be equally long in milliseconds as is the length of the audio frame). Second, the audio signal path (from the second audio driver 3.7 to the actual speaker element 4.1) should have an approximately constant group delay. Third, the audio frame length should be selected carefully. It should be short enough to guarantee a sufficient resolution for the synchronizing parameter 3.12. The inter-ASIC audio protocol should use fixed-length frames. Otherwise, the length of the frames and/or the number of audio samples in the frame (i.e. the length of the audio signal in the frame) should be indicated to the synchronization module 3.9.

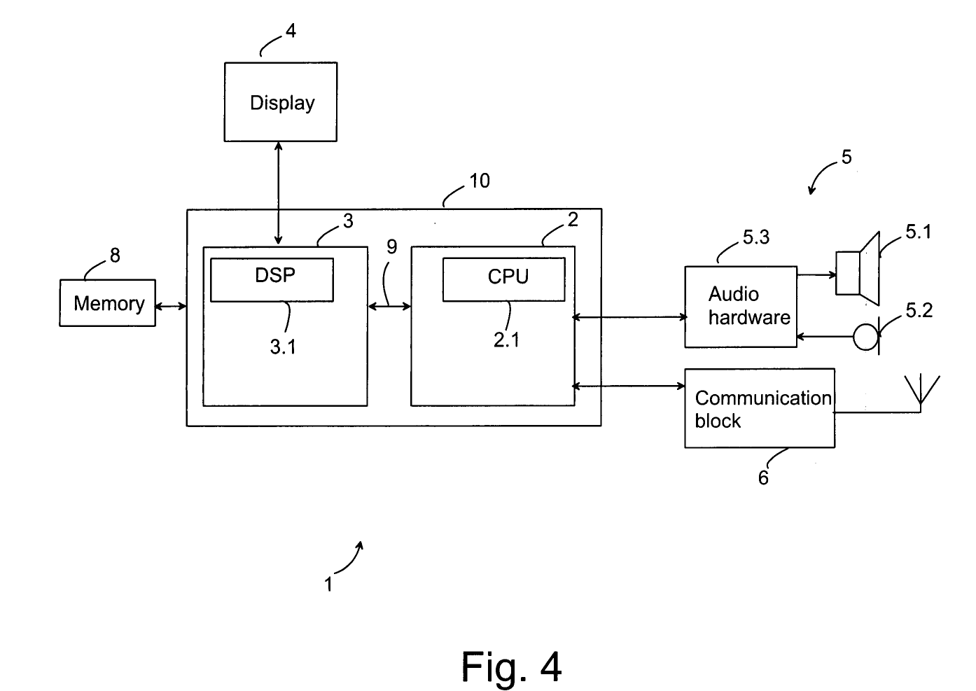

FIG. 4 depicts a device 1 according to another example embodiment of the present invention. In this embodiment the first 2 and the second control block are implemented in the same integrated circuit 10 and the bus 9 is also implemented in the integrated circuit 10.

It is obvious that the present invention is not limited solely to the above described embodiments but it can be varied within the scope of the appended claims.

1. A device comprising at least:
a first control block running a first operating system,
a second control block running a second operating system,
a bus between said-first control block and said second control block for transmitting information between said first control block and said second control block,
an electro-acoustic converter controlled by said first control block for generating an audible signal on the basis of an audio frame, and
video presentation means controlled by said second control block for presenting video information on the basis of video frames,
wherein said first control block is adapted to transmit a request message to said second control block for requesting an audio frame to be transmitted from said second control block to said first control block, and that said first control block is adapted to play out said audio frame via the electro-acoustic converter within a specified time after said request.

2. A device according to claim 1, comprising synchronizing means for synchronizing the presentation of video information to the presentation of audio information on the basis of said request message.

3. A device according to claim 2, said synchronizing means comprising:
a message handler adapted to detect said request message and to increment the value of a synchronizing parameter after a certain amount of audio frames are transmitted from said second control block to said first control block, and
a determinator to examine the value of the synchronizing parameter to determine the timing of the presentation of a video frame.

4. A device according to claim 1, wherein
said first control block comprises a first audio driver for transmitting audio frames to said first control block, and
said second control block comprises a second audio driver for transmitting audio frames to said electro-acoustic converter, said second audio driver also being adapted to operate as said message handler.

5. A device according to claim 1, wherein said request is adapted to be transmitted periodically, the period being substantially the same as the length of the audio frame.

6. A device according to claim 1, wherein the device is adapted to perform the playback of the audio signal at a substantially constant group delay, wherein the time from the transmission of the audio frame to the playback of the audio frame is substantially constant.

7. A device according to claim 1, wherein said first control block and said second control block are implemented in separate integrated circuits.

8. A device according to claim 1, wherein said first control block and said second control block are implemented in the same integrated circuit, wherein the bus is also integrated in the same integrated circuit.

9. A device according to claim 1, wherein it is one of the following a mobile devices:
a wireless communication device,
a mobile phone,
a laptop computer,
a PDA device.

10. A device according to claim 1, wherein both said first operating system and said second operating system are Symbian™ operating systems.

11. A device according to claim 1, wherein said first operating system and said second operating system are different operating systems.

12. A system comprising at least:
a first control block running a first operating system,
a second control block (3) running a second operating system,
a bus between said first control block and said second control block for transmitting information between said first control block and said second control block,
an electro-acoustic converter controlled by said first control block for generating an audible signal on the basis of an audio frame, and
video presentation means controlled by said second control block for presenting video information on the basis of video frames,
wherein said first control block is adapted to transmit a request message to said second control block for requesting an audio frame to be transmitted from said second control block to said first control block, and that said first control block is adapted to play out said audio frame via the electro-acoustic converter within a specified time after said request.

13. A system according to claim 12, comprising synchronizing means for synchronizing the presentation of video information to the presentation of audio information on the basis of said request message.

14. A system according to claim 13, wherein said synchronizing means comprising:
a message handler adapted to detect said request message and to increment the value of a synchronizing parameter after a certain amount of audio frames are transmitted from said second control block (3) to said first control block, and
a determinator to examine the value of the synchronizing parameter to determine the timing of the presentation of a video frame.

15. A system according to claim 12, wherein
said first control block comprises a first audio driver for transmitting audio frames to said first control block, and
said second control block comprises a second audio driver for transmitting audio frames to said electro-acoustic converter, said second audio driver also being adapted to operate as said message handler.

16. A system according to claim 12, wherein said request is adapted to be transmitted periodically, the period being substantially the same as the length of the audio frame.

17. A system according to claim 12, wherein the system is adapted to perform the playback of the audio signal at a substantially constant group delay, wherein the time from the transmission of the audio frame to the playback of the audio frame is substantially constant.

18. A system according to claim 12, wherein said first control block and said second control block are implemented in separate integrated circuits.

19. A system according to claim 12, wherein said first control block and said second control block are implemented in the same integrated circuit, wherein the bus is also integrated in the same integrated circuit.

20. A system according to claim 12, wherein it is one of the following a mobile devices:
a wireless communication device,
a mobile phone,
a laptop computer,
a PDA device.

21. A system according to claim 12, wherein both said first operating system and said second operating system are Symbian™ operating systems.

22. A system according to claim 12, wherein said first operating system and said second operating system are different operating systems.

23. A method for presenting audio and video information in a device, which comprises at least:
a first control block running a first operating system,
a second control block (3) running a second operating system,
a bus between said first control block and said second control block for transmitting information between said first control block and said second control block,
an electro-acoustic converter controlled by said first control block for generating an audible signal on the basis of an audio frame, and
video presentation means controlled by said second control block for presenting video information on the basis of video frames,
wherein the method comprises:
transmitting a request message from said first control block to said second control block for requesting an audio frame to be transmitted from said second control block to said first control block, and
playing out said audio frame via the electro-acoustic converter within a specified time after said request under the control of said first control block.

24. A method according to claim 23, wherein it comprises synchronizing the presentation of video information to the presentation of audio information on the basis of said request message.

25. A method according to claim 24, wherein it also comprises
detecting said request message and incrementing the value of a synchronizing parameter after a certain amount of audio frames are transmitted from said second control block to said first control block, and
examining the value of the synchronizing parameter to determine the timing of the presentation of a video frame.

26. A method according to claim 23, wherein said request is transmitted periodically, the period being substantially the same as the length of the audio frame.

27. A computer program product comprising machine executable steps stored on a readable medium for presenting audio and video information in a device when executed by a processor, which comprises at least:
a first control block running a first operating system,
a second control block running a second operating system,
a bus between said first control block and said second control block for transmitting information between said first control block and said second control block,
an electro-acoustic converter controlled by said first control block for generating an audible signal on the basis of an audio frame, and
video presentation means controlled by said second control block for presenting video information on the basis of video frames,
wherein the computer program product further comprises machine executable steps for:
transmitting a request message from said first control block to said second control block for requesting an audio frame to be transmitted from said second control block to said first control block, and
playing out said audio frame via the electro-acoustic converter within a specified time after said request under the control of said first control block.

28. A computer program product according to claim 27, wherein it comprises machine executable steps for synchronizing the presentation of video information to the presentation of audio information on the basis of said request message.

29. A computer program product according to claim 28, wherein it also comprises machine executable steps for:
detecting said request message and incrementing the value of a synchronizing parameter after a certain amount of audio frames are transmitted from said second control block to said first control block, and
examining the value of the synchronizing parameter to determine the timing of the presentation of a video frame.
